(19) United States
(12) Patent Application Publication
(10) Pub. No.: US 2009/0181846 A1
(43) Pub. Date: Jul. 16, 2009

(54) PROCESS FOR PREPARING CATALYST FOR SYNTHESIS OF CARBON NANOTUBES USING SPRAY PYROLYSIS

(76) Inventors: Joung Hyeon Lim, Suwon City (KR); Young Chul Joung, Suwon City (KR); Jin Seok Oh, Incheon Metropolitan City (KR); Hyun Jin Cho, Yeosu City (KR); Hee Jung Choi, Seongnam City (KR)

Correspondence Address: LADAS & PARRY LLP, 224 SOUTH MICHIGAN AVENUE, SUITE 1600, CHICAGO, IL, 60604, US

(21) Appl. No.: 12/344,181

(22) Filed: Dec. 24, 2008

(30) Foreign Application Priority Data
Dec. 24, 2007 (KR) 10-2007-0136423
Dec. 24, 2007 (KR) 10-2007-0136493

(51) Int. Cl. B01J 23/745; B01J 8/00; B01J 23/755; B01J 23/75; B01J 27/24; B01J 21/10; B01J 21/04

(52) U.S. Cl. 502/200; 422/187; 502/100; 502/338; 502/337; 502/325; 502/340; 502/355

(57) ABSTRACT

An apparatus for preparing a catalyst for carbon nanotubes using spray pyrolysis and a method for preparing the catalyst are disclosed. The apparatus comprises a plurality of raw material tanks, an agitator to mix raw materials respectively supplied from the raw material tanks, a drier to spray the mixture supplied from the agitator and thus to heat and bake the same, and a storage to store a dried material discharged from the drier. The method comprises supplying a plurality of raw materials, mixing the raw materials with one another, spraying the raw material mixture in a liquid state and drying the same at a high temperature, and storing a catalyst generated in the drying process.

### BACKGROUND OF THE INVENTION

1. Field of the Invention

The present invention relates to an apparatus for preparing a catalyst for carbon nanotubes using spray pyrolysis and a method for preparing the catalyst. More particularly, the present invention relates to an apparatus for preparing a catalyst for carbon nanotubes using spray pyrolysis and a method for preparing the catalyst, wherein a constant amount of regents can be supplied, a continuous process can be realized, and highly pure catalysts can be continuously synthesized, without any baking process, by rapidly drying reagents by a high temperature of heat generated from a heater which heats a drying furnace wherein the liquid reagents are supplied through a nozzle to a reactor.

2. Description of the Related Art

Carbon nanotubes (CNTs) refer to allotropes of carbon composed of carbons rich on earth, which have a structure in which each carbon atom is bonded to adjacent carbon atoms in the form of a hexagonal honeycomb to form a tube, and are an extremely small material having a diameter of nanometers (nm: 10⁻⁹ m).

The recent nanoscience technology has attracted much attention as a science technology leader for the 21^{th} century, which is in the spotlight as the next generation in the field of electronics, information telecommunication, medicine, material science, environment and energy. Of these fields, carbon nanotubes (CNTs) realize new characteristics of materials, and the importance of fundamental study and industrial applicability thereof are thus intensely in the spotlight.

Fullerenes (aggregates of 60 carbons: C₆₀), one of allotropes of carbon, had been discovered by Kroto and Smalley in 1985. Then, while making a research on such a new material, the doctor Iijima in the electric company NEC located in Japan in 1991 discovered a thin and long tubular carbon nanotube in the process of forming a carbon mass on a graphite using an arc-discharge method and then analyzing the carbon mass by TEM and then firstly reported in the journal Nature.

The carbon nanotubes grown have a length of several tens of nm to several meters and an external diameter of 2.5 to 30 nm. The carbon nanotube has a structure wherein one carbon atom is bonded to another three carbon atoms in the form of sp² bonds to form a hexagonal honeycomb. Such a material refers to a “carbon nanotube”, because its diameter is extremely small, i.e., about several nanometers.

In 1992, Ebbesen, Ajayan, et al. reported that, when carbon nanotube is synthesized at an elevated helium pressure in a chamber using an arc-discharge method, a yield of carbon nanotube deposited on a graphite cathode is greatly increased. In 1993, Bethune et al., in IBM and Iijima et al., in NEC reported synthesis of single walled nanotubes (SWNTS) having a diameter of about 1 nm using an arc-discharge method. Subsequently, in 1996, Smalley, et al. reported a method for growing a high yield of SWNTs having a uniform diameter with laser vaporization [2]. SWNTs grown by this method are in the form of bundles and are thus referred to as “rope nanotubes”. Since, in 1998, Ren et al. synthesized highly pure carbon nanotubes vertically oriented on a glass substrate by plasma chemical vapor deposition [3], synthesis and application technologies of carbon nanotubes have been rapidly progressed. Then, a great deal of research associated with synthesis and application of carbon nanotube are being actively made.

These carbon nanotubes are prepared by an arc-discharge method, laser deposition, vapor deposition, electrolysis and etc. The vapor deposition may employ a substrate or not. A method for synthesizing carbon nanotubes, wherein a catalyst is directly supplied into a reactor in the absence of a reaction gas and a substrate is advantageous in mass-producing carbon nanotubes.

Methods for preparing catalysts used for synthesis of carbon nanotubes include implantation, ion-exchange and precipitation methods. Methods for synthesizing carbon nanotubes suggested to date will be illustrated as follows:

1) Sol-Gel Method

Methods for preparing catalysts through sol-gel reactions comprise mixing a transition metal precursor such as iron (Fe) nitrate with a network-forming material such as tetraethoxysilane (TEOS) and an alumina precursor in the presence of an aqueous ethanol solution, gelling the mixture for several hours, and subjecting the gel to supercritical drying and baking processes to remove the solvent. The network-forming material serves to stabilize catalyst particles and prevent occurrence of sintering during heating.

2) Implantation

Implantation is a method wherein a catalyst precursor comes in contact with a generally-used support such as silica, alumina or MgO, and a catalyst solution is implanted into external and internal pores of a porous support to induce adsorption.

3) Solid Solution Method

A solid solution method is a method for preparing a catalyst wherein two precursors of Co(NO₃)₂6H₂O and Mg(NO₃)₂6H₂O are mixed with urea as a foaming agent or an organic compound such as citric acid, heating the mixture at about 500° C. to induce combustion, followed by drying and grinding. A Mo precursor as a co-catalyst may be also used to prepare catalysts.

4) Ion-Exchange Method

The use of an ion-exchange method advantageously enables uniform distribution of a catalyst material. In view of the fact that a catalyst precursor is in contact with zeolite, the ion-exchange method is the same as the aforementioned methods. However, zeolite has cation-exchange capacity, thus resulting in ion-exchange between cations of a catalyst precursor and anions of zeolite, and then formation of a new precursor molecule. Then, the catalyst precursor undergoes thermal decomposition to form oxidized catalyst particles on the zeolite surface. To obtain the desired amount of catalyst, ion-exchange may be repeated several times.

5) Co-Precipitation

When a support material is immersed in a catalyst precursor such as Co(H₃C—CO₂)₂4H₂O, acid-base reactions occur on the support surface and at the same time, the initial catalyst precursor is precipitated. In this reaction, pH of the initial catalyst has an important role. When alumina is immersed in an aqueous solution, the electric potential of the surface is varied depending on pH of the solution. When the solution is acid, the support surface is positively charged and anionic active material is well adsorbed thereon. When the solution is alkaline, the support surface is negatively charged and cationic active material is well adsorbed thereon. This behavior is related to distribution of charges on the solid surface. In particular, a pH value wherein the surface charge is 0, is referred to as an “isoelectric point”.

6) Reverse Micelle Method

In accordance with this method, a cationic surfactant is dissolved in an organic solvent such as toluene, a metal salt is added to the solution and a reducing agent is added thereto to reduce the oxidized metal. As a result, colloidal nano-scaled catalyst particles are formed. In accordance with this method, CNTs can be synthesized by spraying a colloidal nano-scaled catalyst solution into a CVD reactor, but the concentration of the nanocatalyst cannot be greatly increased and production efficiency of CNTs is disadvantageously low.

7) Pyrolysis of Carbonyl Compound

Metal nanocatalyst particles can be prepared in the form of clusters by subjecting the carbonyl compound to pyrolysis. An additive such as octanoic acid to minimize aggregation of the carbonyl compound is added to ether as a solvent and the reactants are then refluxed to induce pyrolysis. Alternatively, nanocatalyst particles may be prepared by injecting an organometallic compound such as Fe(CO)₅ or Ni(CO)₅ into the reactor through a carrier gas and then undergoing the same pyrolysis on a substrate.

These methods enable preparation of catalysts for synthesizing carbon nanotubes on a small scale, but have a disadvantage of a high final price of carbon nanotubes due to the absence of mass-production techniques capable of securing economic efficiency.

### SUMMARY OF THE INVENTION

Therefore, the present invention has been made in view of the above problems, and it is an object of the present invention to provide an apparatus for preparing a catalyst for carbon nanotubes using spray pyrolysis and a method for preparing the catalyst, wherein a constant amount of regents can be supplied, a continuous process can be realized, and highly pure catalysts can be continuously synthesized, without any baking process, by rapidly drying reagents by a high temperature of heat generated from a heater which heats a drying furnace wherein the liquid reagents are supplied through a nozzle to a reactor.

In accordance with the present invention, the above and other objects can be accomplished by the provision of an apparatus for preparing a catalyst for carbon nanotubes using spray pyrolysis, comprising: a plurality of raw material tanks; an agitator to mix raw materials respectively supplied from the raw material tanks; a drier to spray the mixture supplied from the agitator and thus to heat and bake the same; and a storage to store a dried material discharged from the drier.

The drier may be spray the mixture supplied from the agitator, induces pyrolysis of the mixture in a drying furnace, and cools the catalyst and then discharges the same to the outside. The drier may spray the mixture together with a carrier gas. The drier may further comprise an activating agent. The activating agent may purify the raw material mixture.

The carrier gas may include one selected from nitrogen (N₂) and argon (Ar).

The drier may spray the raw material mixture using one selected from internal and external mixing types.

The raw material tanks may supply catalyst preparation groups selected from Fe, Ni, Co or precursors thereof, magnesium (Mg) or precursors thereof, molybdenum (Mo) or precursors thereof, and ammonia.

In accordance with an aspect of the present invention, the above and other objects can be accomplished by the provision of a method for preparing a catalyst for carbon nanotubes using spray pyrolysis, comprising: supplying a plurality of raw materials; mixing the raw materials with one another; spraying the raw material mixture in a liquid state and drying the same at a high temperature; and storing a catalyst generated in the drying process.

In the step of supplying the raw materials, the raw materials for catalyst may be selected from Fe, Ni, Co or precursors thereof, aluminum (Al) or precursors thereof, Mg or precursors thereof, molybdenum (Mo) or precursors thereof, and ammonia.

The step of mixing the raw material may be carried out for 20 to 24 hours.

The step of drying the raw material mixture may be carried out at 200 to 1,100° C.

The step of spraying the raw material mixture may be carried out by spraying the raw material mixture into a drying furnace at a rate of 20 to 21 ml/h and subjecting the mixture to free fall.

The step of spraying the raw material mixture may be carried out by spraying the mixture together with a carrier gas through the nozzle and the carrier gas is selected from nitrogen (N₂) and argon (Ar).

The step of spraying the raw material mixture further may comprise purifying the raw material mixture.

The step of purifying the raw material mixture may be carried out by spraying an activating agent together with the raw material mixture.

The activating agent may purify the raw material mixture and may be oxygen (O₂).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an apparatus for preparing a catalyst for carbon nanotubes according to the present invention;

FIG. 2 is a cross-sectional view illustrating a drier shown in FIG. 1;

FIGS. 3A and 3B are cross-sectional views illustrating the nozzle shown in FIG. 2;

FIG. 4 is a block diagram illustrating a method for preparing an apparatus for preparing a catalyst for carbon nanotubes; and

FIG. 5 is a microphotograph showing the structure of a catalyst for carbon nanotubes according to the present invention.

### DETAILED DESCRIPTION OF THE INVENTION

Hereinafter, preferred embodiments of the present invention will be illustrated with reference to the annexing drawings in detail. Those skilled in the art will appreciate that various modifications, additions, and substitutions to the specific examples are possible, without departing from the scope and spirit of the invention. These embodiments are given for the purpose of illustration and are not to be construed as limiting the scope of the invention. Accordingly, in the drawings, the size and thickness of elements are exaggerated for clarity of the present invention.

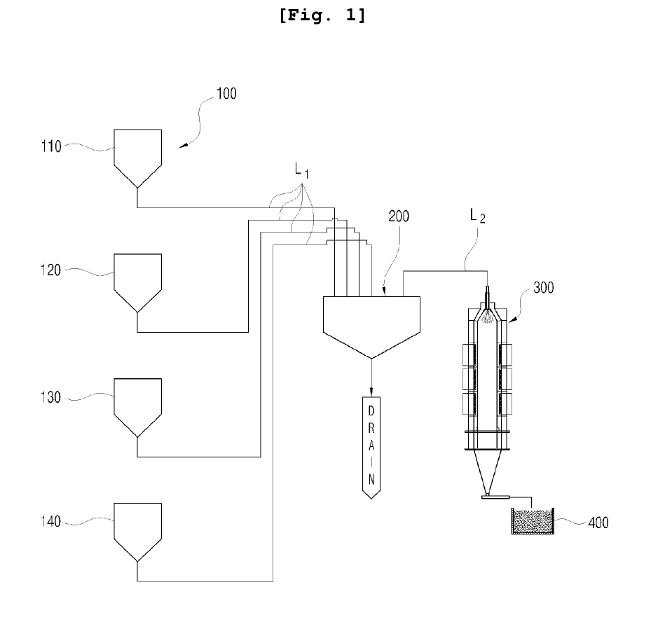

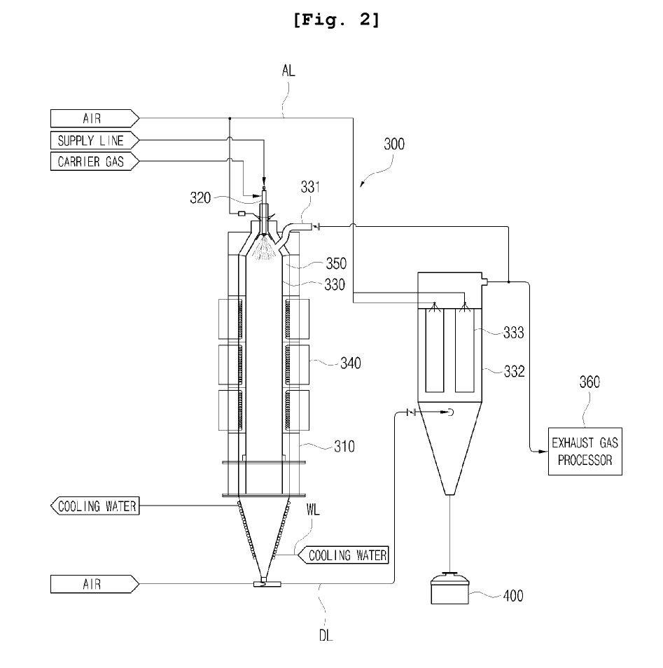

As shown in FIGS. 1 and 2, an apparatus for preparing catalysts 10 comprises a raw material supplier 100, an agitator 200, a drier 300 and a storage 400.

The raw material supplier 100 consists of a plurality of raw-material tanks 110, 120, 130, 140, each including a major catalyst, a co-catalyst, a supporter to support catalysts and a liquidizing agent to liquidize the raw materials. Examples of raw-materials include iron (Fe), nickel (Ni), cobalt (Co), aluminum (Al), molybdenum (Mo), silicon (Si), zeolite and ammonia. The catalyst preparation groups selected from Fe, Ni, Co or precursors thereof, aluminum (Al) or precursors thereof, magnesium (Mg) or precursors thereof, molybdenum (Mo) or precursors thereof, and ammonia are separately supplied. That is, raw material groups, each consisting of one and more catalyst materials, a supporter to fix the materials and a liquid to liquidize catalysts are separately supplied.

The agitator 200 is provided with a pair of tanks with a suitable size, which receives a raw material through a raw material supply line L1 from the raw material supplier 100. The raw material supplied to the agitator is mixed therein for a predetermined long time, preferably 20 to 24 hours. This agitating time enables suitable mixing of raw materials. When the agitating time is too long, supply of raw materials to prepare catalysts cannot be suitably realized, and when the agitating time is too short, mixing of raw materials is not homogeneous. For this reason, through a pair of agitators wherein one of the agitators is agitated, while the other thereof supplies a raw material mixture, catalysts can be continuously prepared.

The drier 300 comprises a nozzle 320 which receives raw material mixtures from the agitator 200 through the raw material supply line L2 and sprays the raw material into a drying furnace 330, a heater 340 which dries the sprayed raw material mixture, and a heat insulator 350 to prevent heat from emitting outside. In addition, the nozzle 320 serves to mix-spray the raw material mixture and a carrier gas therein. An upper body of the drying furnace 330 is provided with an outlet 331, communicating the drying furnace 330, through which an exhaust gas is discharged. In addition, the upper body further comprises a dust collector 332 and an exhaust gas processor 360 to clean the exhaust gas. An upper part of a filter 333 provided in the dust collector 332 is connected to an air supply line AL through which air is supplied from the outside. A lower part of the filter 333 is connected to a discharge line DL, enabling the catalysts contained in the exhaust air to be collected in the storage. The body 310 of the drying furnace is connected to a raw material supply line L2 and a nozzle 320, through which a raw material mixture is sprayed.

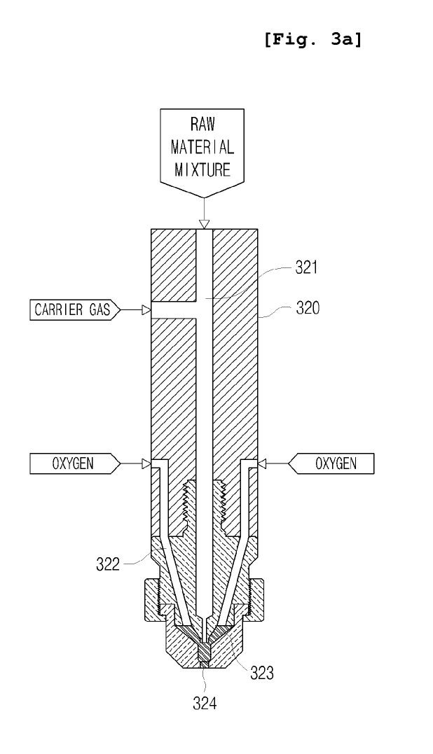

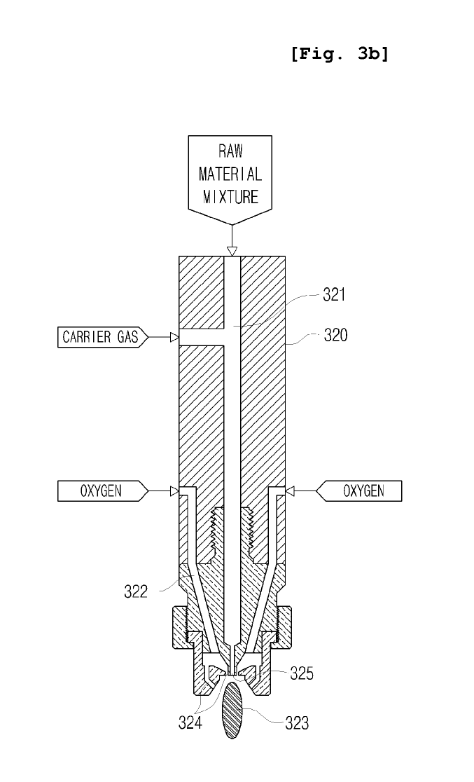

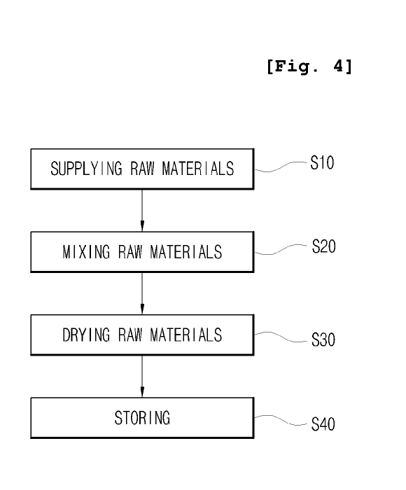

In addition, as shown in FIGS. 3A and 3B, the nozzle 320 comprises a carrier gas supply opening 321a, which transfers the raw material mixture in the drying furnace, is connected to a raw material mixture supply channel 321, enabling supply of the gas from the outside. A lower part of the carrier gas supply opening 321a comprises an activating agent supply channel 322, wherein the carrier gas is mixed with the activating agent, arranged adjacent to a raw material mixture supply channel. The nozzle may be selected from internal mixing wherein the carrier gas is already mixed with the raw material mixture inside the nozzle and the activating agent is further mixed with the resulting mixture therein, and external mixing wherein the activating agent is mixed outside the nozzle. That is, in the case of the internal mixing, a carrier gas, an activating agent and a raw material mixture are mixed with one another in a space 323 present therein, and the mixture is sprayed through a nozzle opening 324. In the case of external mixing, the carrier gas is mixed with mixed materials, the resulting mixture is then sprayed through a nozzle opening 325, the activating agent is sprayed through another nozzle opening 324 in a position adjacent to the nozzle opening 325, to mix the materials with one another in a space 323 outside nozzle openings 324 and 325. The activating agent serves to purify the raw material mixture inside the drying furnace and uses oxygen (O₂).

The carrier gas may be nitrogen (N₂) or argon (Ar). This carrier gas serves to prevent adsorption of the raw material mixture on the sidewall of drying furnace and thus to promote occurrence of catalysts due to high-temperature drying, and furthermore, serves to supply oxygen to the raw material mixture and thus to maximize the activation degree of catalysts.

The drying furnace 330 is formed lengthwise from the nozzle downward, a plurality of heaters 340 to heat the drying furnace are arranged in a longitudinal direction while surrounding the circumference of the drying furnace, and a cooling line WL to cool the heated catalyst is provided in a lower part. The heating temperature of the heater is preferably 200 to 1100° C.

When the heating temperature is excessively high, the raw material mixture is vaporized due to the heat, and when the heating temperature is excessively low, the raw material mixture cannot be sufficiently heated during free fall.

A dust collector 332 is arranged in the side of the outlet 331 provided in the drying furnace 310, a filter 333 is provided in the dust collector 332, an air supply line connected to a upper side of the filter 333 extends to the air supply line (AL) connected to the nozzle, allowing the catalyst to be collected through the dust collector 332 and then stored in the storage 400.

The exhaust gas processor employs a general technique for disposing a waste gas and detailed description thereof is thus omitted.

The storage 400 serves to store the catalyst formed in the drier 300. A discharge line DL is provided below the drier 300, which enables the catalyst generated by an external air to be transmitted to the storage 400.

In the operation mode of the present invention, raw materials to prepare the catalyst are supplied from the respective raw material tanks 110, 10, 130 and 140 of the material supplier 100.

The raw material is contained in the agitator 200 along raw material supply line L1. At this time, the raw material selected from iron (Fe), nickel (Ni), cobalt (Co), aluminum (Al), molybdenum (Mo), silicon (Si), zeolite and ammonia is supplied through the raw material supply line. The catalyst preparation groups selected from Fe, Ni, Co or precursors thereof, aluminum (Al) or precursors thereof, magnesium (Mg) or precursors thereof, molybdenum (Mo) or precursors thereof, and ammonia are separately supplied. That is, raw material groups, each consisting of one and more catalyst materials, a supporter to fix the materials and a liquid to liquidize catalysts are separately supplied.

Then, the raw material contained in the agitator 200 is mixed through an agitation process for a predetermined time of 20 to 24 hours and is then supplied through the raw material supply line (L2) to the drier 300. The drier 300 sprays the raw material mixture together with a carrier gas through a nozzle 320. The nozzle enables an activating agent to be mixed and then sprayed to the inside of the drying furnace 330, apart from the mixture of the carrier gas and the raw material mixture. The nozzle may spray the raw material mixture in accordance with the spraying type of the activating agent selected from external mixing and internal mixing.

Then, the sprayed raw material mixture undergoes free fall inside the drying furnace, is dried at a high temperature by the heater, and is activated by the catalyst in the process of drying. The activated catalyst is cooled, while passing through a cooling line (AL) provided in a lower part of the drying furnace. The cooled catalyst is discharged to the outside through a discharge line (DL) and is then stored. Since the discharge line (DL) is connected to the dust collector 332, the catalyst flows in the dust collector and is collected by the filter 333 therein. The collected catalyst is stored in the storage 400 connected to a lower part of the dust collector, based on the principle that the filter is emptied at regular intervals through an air supply line (AL) provided in an upper part of the filter. After passing through the filter, the air moves toward the exhaust gas processor and is then discharged.

Hereinafter, a method for preparing the catalyst according to the present invention will be illustrated.

The method for preparing a catalyst for carbon nanotubes using spray pyrolysis comprises: supplying a plurality of raw materials (S10); mixing the raw materials with one another (S20); spraying the raw material mixture in a liquid state and drying the same at a high temperature (S30); and storing a catalyst generated in the drying process.

The step S10 is a process wherein raw materials are supplied from a plurality of raw material tanks which contain different raw materials to the agitator. In the step S10, catalyst preparation groups selected from Fe, Ni, Co or precursors thereof, aluminum (Al) or precursors thereof, Mg or precursors thereof, molybdenum (Mo) or precursors thereof, and ammonia are separately supplied. That is, the raw materials are used as a major catalyst, a co-catalyst and a supporter, and also supply a liquid to liquidize a compound of these components.

In the step S20, raw materials supplied in the step S10 are mixed with one another, and the supplied raw materials are accepted in a pair of agitators and then agitated therein, thereby continuously supplying the raw material mixture. The raw materials are agitated for a mixing time of 20 to 24 hours, thus enabling continuous supplying. That is, the mixing of the raw material mixture supplied from one agitator is carried out until mixing of the raw material mixture in the other agitator is completed, thereby performing a continuous process.

In the step S30, the raw material mixture mixed in the step S20 is moved through the supply line to the nozzle and is then sprayed through the nozzle inside the drying furnace. In this step, the raw material mixture is sprayed together with a carrier gas through the nozzle. During spraying, the raw material mixture passes through the drying furnace due to free fall. The step S30 further comprises a purification process. The purification process enables spraying of the raw material mixture and the activating agent contained in the sprayed carrier gas. The raw material mixture may be mixed with the activating agent inside or outside the nozzle. That is, an external mixing mode wherein the raw material mixture is mixed with the carrier gas and an activating agent is separately sprayed outside the nozzle, and an internal mixing mode wherein the raw material mixture, a carrier gas and an activating agent are mixed with one another inside the nozzle and the resulting mixture is then sprayed. The activating agent is sprayed together with the raw material mixture, and then reacts with a catalyst during drying to remove and purify the impurity contained in the catalyst. As the activating agent, oxygen (O2) may be used.

Meanwhile, the raw material mixture sprayed through the nozzle has particles with a size of 1 μm to 10 μm and is sufficiently dried in the drying furnace to form a catalyst.

In addition, the carrier gas may use one selected from nitrogen (N₂) and argon (Ar), and the raw material mixture is sprayed in the drying furnace at a rate of 20 to 21 ml/h, while undergoing free fall, and is then dried at 200 to 1,100° C. therein. When the heating temperature is excessively high, the raw material mixture is vaporized, and when the heating temperature is excessively low, the raw material mixture cannot be sufficiently heated during free fall. The temperature of the drying furnace may be controlled, taking consideration into the fall rate of raw material mixture. That is, the raw material mixture is sprayed in a constant amount and rate through the nozzle, thereby constantly maintaining an amount of the catalyst to be finally formed, uniformly drying the mixture in the dying furnace, and realizing uniformity of the catalyst formed.

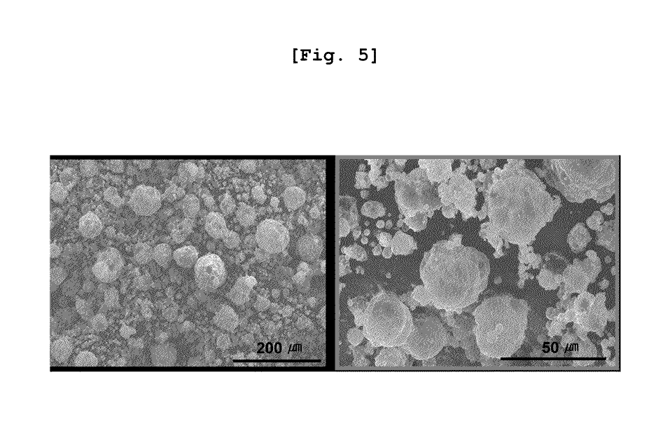

As shown in FIG. 5, the activating agent to purify the catalyst is sprayed together with the raw material mixture, thereby taking the catalyst into the empty spherical particle shape and maximizing the capability of activating carbon nanotubes.

The step S30 may further comprise discharging a waste gas generated during drying of the raw material mixture to purify the catalyst.

In the step S40, the catalyst formed in the step S30 is stored by air movement.

As apparent from the fore-going, an apparatus for preparing a catalyst for carbon nanotubes using spray pyrolysis and a method for preparing the catalyst, wherein a constant amount of liquid or slurry reagents (or mixtures thereof) can be continuously introduced into a drying furnace, and highly pure catalysts can be continuously synthesized, without any baking process, by rapidly drying reagents by a high temperature of heat in a drying furnace where the liquid reagents are supplied through a micro nozzle to a reactor.

In addition, uniform-sized catalysts for carbon nanotubes can be obtained and uniformity of carbon nanotubes obtained can be thus realized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for preparing a catalyst for carbon nanotubes using spray pyrolysis, comprising:
a plurality of raw material tanks;
an agitator to mix raw materials respectively supplied from the raw material tanks;
a drier to spray the mixture supplied from the agitator and thus to heat and bake the same; and
a storage to store a dried material discharged from the drier.

2. The apparatus according to claim 1, wherein the drier serves to spray the mixture supplied from the agitator, induce pyrolysis of the mixture in a drying furnace, and cool the catalyst and then discharge the same to the outside.

3. The apparatus according to claim 2, wherein the drier sprays the mixture together with a carrier gas.

4. The apparatus according to claim 3, wherein the drier further comprises an activating agent.

5. The apparatus according to claim 4, wherein the activating agent purifies the raw material mixture.

6. The apparatus according to claim 3, wherein the carrier gas includes one selected from nitrogen (N₂) and argon (Ar).

7. The apparatus according to claim 3 or 4, wherein the drier sprays the raw material mixture using one selected from internal and external mixing types.

8. The apparatus according to claim 1, wherein the raw material tanks supply catalyst preparation groups selected from Fe, Ni, Co or precursors thereof, magnesium (Mg) or precursors thereof, molybdenum (Mo) or precursors thereof, and ammonia.

9. A method for preparing a catalyst for carbon nanotubes using spray pyrolysis, comprising:
supplying a plurality of raw materials;
mixing the raw materials with one another;
spraying the raw material mixture in a liquid state and drying the same at a high temperature; and
storing a catalyst generated in the drying process.

10. The method according to claim 9, wherein in the step of supplying the raw materials, the raw materials for catalyst are selected from Fe, Ni, Co or precursors thereof, aluminum (Al) or precursors thereof, Mg or precursors thereof, molybdenum (Mo) or precursors thereof, and ammonia.

11. The method according to claim 9, wherein the step of mixing the raw material is carried out for 20 to 24 hours.

12. The method according to claim 9, wherein the step of drying the raw material mixture is carried out at 200 to 1,100° C.

13. The method according to claim 11, wherein the step of spraying the raw material mixture is carried out by spraying the raw material mixture into a drying furnace at a rate of 20 to 21 ml/h and subjecting the mixture to free fall.

14. The method according to claim 13 wherein the step of spraying the raw material mixture is carried out by spraying the mixture together with a carrier gas through the nozzle and the carrier gas is selected from nitrogen (N₂) and argon (Ar).

15. The method according to claim 14, wherein the step of spraying the raw material mixture further comprises purifying the raw material mixture.

16. The method according to claim 15, wherein the step of purifying the raw material mixture is carried out by spraying an activating agent together with the raw material mixture.

17. The method according to claim 16, wherein the activating agent purifies the raw material mixture.

18. The method according to claim 17, wherein the activating agent is oxygen (O₂).
